(19) United States
(12) Patent Application Publication
(10) Pub. No.: US 2019/0078383 A1
(43) Pub. Date: Mar. 14, 2019

(54) ADJUSTING MODULE FOR A WINDOW BLIND

(71) Applicant: NIEN MADE ENTERPRISE CO., LTD., Taichung (TW)

(72) Inventors: CHIH-YAO CHANG, Taichung (TW); Shaun WELSH, Tyne & Wear (GB)

(21) Appl. No.: 15/702,125

(22) Filed: Sep. 12, 2017

(51) Int. Cl. E06B 9/382; E06B 9/28

(52) U.S. Cl. CPC E06B 9/382; E06B 9/28

(57) ABSTRACT

An adjusting module adapted for a window blind is disclosed. The window blind includes a headrail, a slat, a drum and a ladder cord. The drum and the ladder cord are disposed in the headrail. The ladder cord includes a first longitudinal cord, and is detachably connected to the drum. The slat is below the headrail. The adjusting module includes at least one protrusion member which is detachably disposed on the drum. With the first longitudinal cord passing around and contacting the first protrusion member, a length of the first longitudinal cord received inside the headrail is increased, and a length thereof between the bottom of the headrail and the slat is decreased, whereby to pull up a lower side of the inclined slat, so as to adjust the slat to horizontal.

### BACKGROUND OF THE INVENTION

### 1. Technical Field

The present invention is related to a window blind, and more particularly related to an adjusting module capable of adjusting a height of slats of a window covering.

### 2. Description of Related Art

As shown in FIG. 1 to FIG. 3, a conventional window blind includes a headrail 1, a moving rail 2 and a plurality of slats 3. Wherein, the headrail 1 is mounted on a window frame or a building structure. The moving rail 2 is operable to move toward or away from the headrail 1. The slats 3 are suspended between the headrail 1 and the moving rail 2 through a first longitudinal cord 4a and a second longitudinal cord 4b of each ladder cord 4. The first longitudinal cord 4a and the second longitudinal cord 4b are respectively disposed on a front side and a rear side of the slats. The first longitudinal cord 4a and the second longitudinal cord 4b extend vertically, each of which is connected to a drum 5 disposed in the headrail 1 with an upper end thereof, and is connected to the moving rail 2 with a lower end thereof. In addition, a plurality of traverse cords 4c are connected between the first longitudinal cord 4a and the second longitudinal cord 4b. The slats 3 are disposed on the traverse cords 4c. A length of the first longitudinal cord 4a received inside of the headrail 1 is defined as a first routing length L1, and another length of the first longitudinal cord 4a between a bottom edge of the headrail 1 and the slat 3 closest to the headrail 1 is defined as a first segment length S1. By rotating the drums 5, one of the first longitudinal cord 4a and the second longitudinal cord 4b of each ladder cord 4 is pulled up, while the other one is released down, so that a tilt angle of the slats 3 can be changed to adjust an amount of light passing between the slats 3.

However, in practice, due to various reasons in the manufacturing or assembling processes, the slats of a window blind may tilt sideways as illustrated by the imaginary lines shown in FIG. 1, or tilt forward or backward as illustrated by the imaginary lines shown in FIG. 2. The tilting of the slats would substantially affect the quality of the window blind. The cause for such tilting is that, in the case that the ladder cords 4 on the left and right sides of the window blind each has the first longitudinal cord 4a and the second longitudinal cord 4b connected to the corresponding drum 5 through knotting or using a fastener, if the knots or the positions of the fasteners on both sides do not properly correspond to each other, then the slats 3 would tilt in one direction. To solve the problems mentioned above, it usually has to release the first longitudinal cord 4a or the second longitudinal cord 4b of one of the ladder cords 4 from the corresponding drum 5 to change the position of the knot or the fastener thereon, and then reconnect the released longitudinal cord 4a or 4b to the drum 5 again. However, the above process increases the working time for assembling the window blind, and lowers the efficiency. If it takes several times to perform the above process to maintain the slats in a horizontal state, the assembling efficiency of the window blind would be seriously affected.

If the aforementioned situation is not noticed until the window blind has been mounted on a window frame or a building structure, it needs to remove the window blind from the window frame or the building structure to change the position of the knot or the fastener on the first longitudinal cord 4a or the second longitudinal cord 4b of one of the ladder cord 4, and then reinstall the window blind to the window frame or the building structure again, which is inconvenient and burdensome. If the assembling process is performed by the consumer his or herself, it would be really bothersome for the consumer.

### BRIEF SUMMARY OF THE INVENTION

In view of the above, one aspect of the present invention is to provide an adjusting module for a window blind. The adjusting module is capable of adjusting inclined slats into a horizontal state.

The present invention provides an adjusting module for a window blind. The window blind includes a headrail, a slat, a drum and a ladder cord. The drum is disposed in the headrail in a rotatable manner. The ladder cord includes a first longitudinal cord and a second longitudinal cord. An upper end of each of the first longitudinal cord and the second longitudinal cord is detachably connected to the drum. The slat is below the headrail, and is disposed between the first longitudinal cord and the second longitudinal cord. A length of the first longitudinal cord received inside the headrail is defined as a first routing length, and a length of the first longitudinal cord between a bottom edge of the headrail and the slat is defined as a first segment length. The adjusting module includes a first protrusion member disposed in the headrail. When the first longitudinal cord passes around and contacts the first protrusion member, a length of the first longitudinal cord received inside the headrail is defined as a second routing length, and a length of the first longitudinal cord between the bottom edge of the headrail and the slat is defined as a second segment length. The second routing length is longer than the first routing length, and the second segment length is shorter than the first segment length.

With the aforementioned design, a moving path of the ladder cord could be changed through the collaboration between the first protrusion member and the drum, for the ladder cord could wind around the first protrusion member. Whereby, a downwardly inclined side of the slats could be pulled up to make the slats horizontal.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a conventional window blind;

FIG. 2 is a side view of the conventional window blind;

FIG. 3 is a partial enlarged view of the conventional window blind of FIG. 2;

FIG. 4 is an exploded view of the adjusting module of a first embodiment of the present invention and the drum;

FIG. 5 is another exploded view of the adjusting module of the first embodiment and the drum which is illustrated from a view angle different from that of FIG. 4;

FIG. 6 is a perspective view of a combined structure of the adjusting module of the first embodiment and the drum;

FIG. 7 is an exploded view of the adjusting module of the first embodiment;

FIG. 8 is another exploded view of the adjusting module of the first embodiment which is illustrated from a view angle different from that of FIG. 8;

FIG. 9 is a cross-sectional view of the adjusting module and the drum along the 9-9 line in FIG. 6;

FIG. 10 is a cross-sectional view of the adjusting module and the drum along the 10-10 line in FIG. 6;

FIG. 11 is a cross-sectional view of the adjusting module and the drum along the 11-11 line in FIG. 6;

FIG. 12 is an exploded view of the adjusting module of a second embodiment of the present invention and the drum;

FIG. 13 is a perspective view of a combined structure of the adjusting module of the second embodiment and the drum;

FIG. 14 is a cross-sectional view of the adjusting module and the drum along the 14-14 line in FIG. 13;

FIG. 15 is a cross-sectional view of the adjusting module and the drum along the 15-15 line in FIG. 13;

FIG. 16 is an exploded view of the adjusting module of a third embodiment of the present invention and the drum;

FIG. 17 is a perspective view of the adjusting module of the third embodiment and the drum;

FIG. 18 is a front view of the adjusting module of a fourth embodiment of the present invention and the drum;

FIG. 19 is a side view of the adjusting module of the fourth embodiment and the drum;

FIG. 20 is a perspective view of the adjusting module of a fifth embodiment of the present invention and the drum;

FIG. 21 is a perspective view of the adjusting module of the fifth embodiment of the present invention and the drum;

FIG. 22 is a top view of the adjusting module of the fifth embodiment of the present invention and the drum; and

FIG. 23 is a front view of the adjusting module of the fifth embodiment of the present invention and the drum.

### DETAILED DESCRIPTION OF THE INVENTION

The present invention provides at least one first protrusion member on a drum to change a moving path of a first longitudinal cord of a ladder cord, such that the slats could be adjusted into a horizontal state without the need to retie a knot or reposition a fastener on the ladder cord. The following illustrative embodiments and drawings are provided to illustrate the disclosure of the present invention. These and other advantages and effects can be clearly understood by persons skilled in the art after reading the disclosure of this specification.

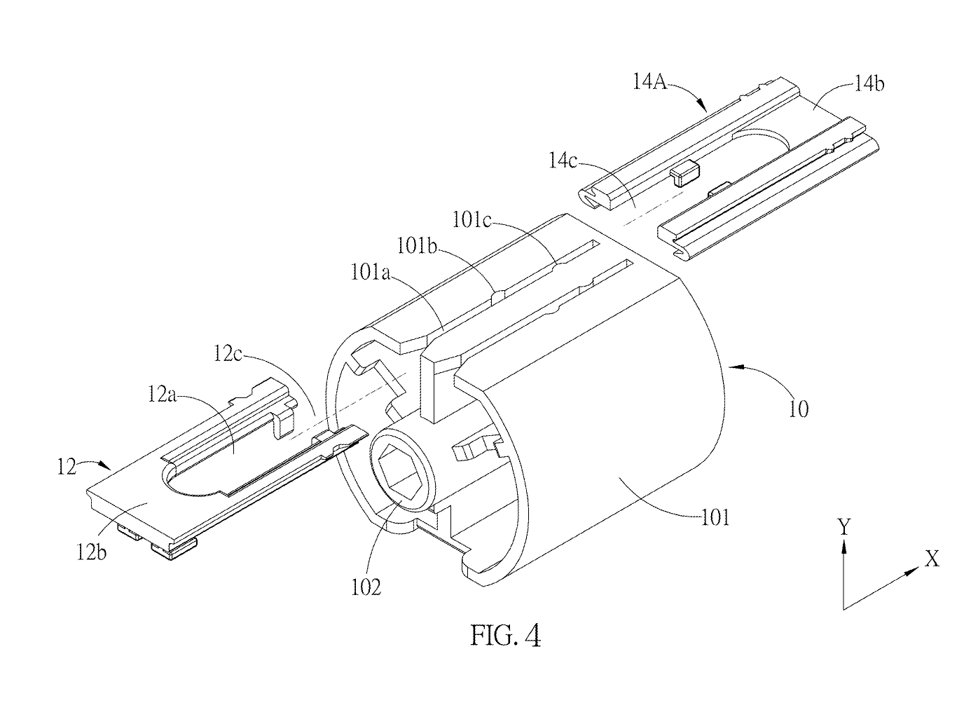

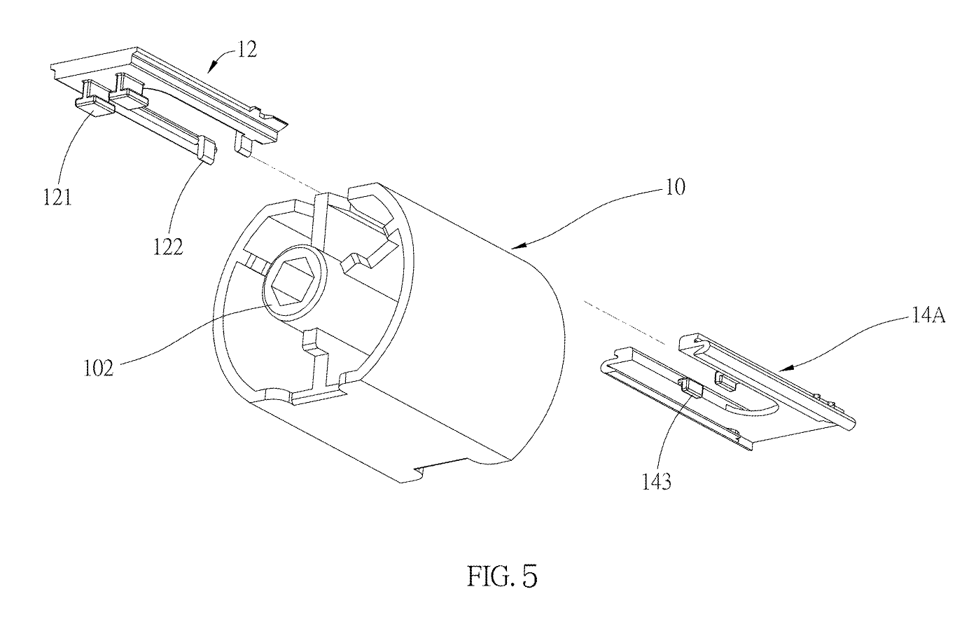

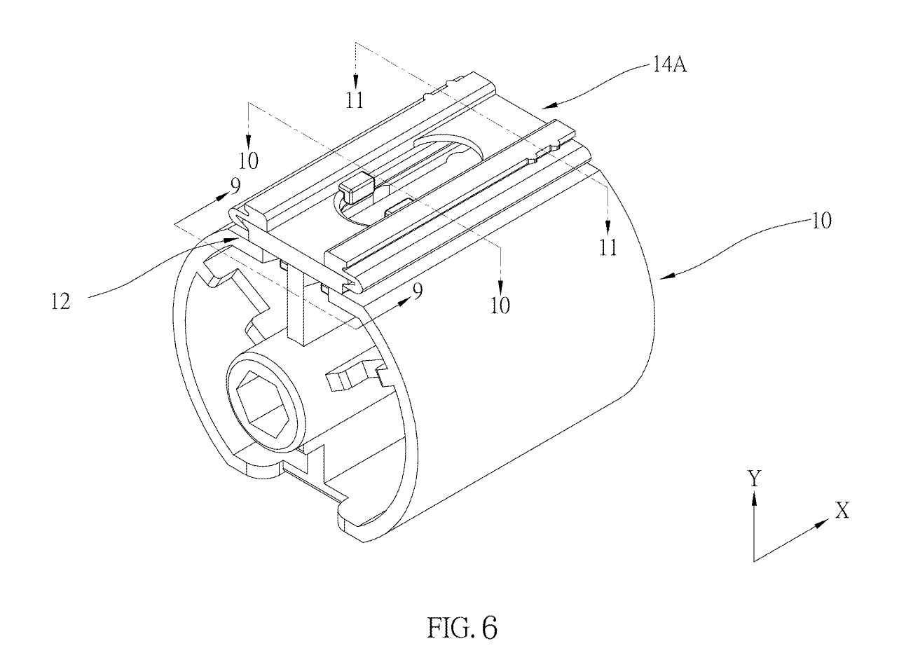

As shown in FIG. 4 to FIG. 11, an adjusting module of a first embodiment of the present invention, which is adapted for a window blind, is illustrated. The window blind includes a headrail 1, a plurality of slats 3, a ladder cord 4 and a drum 10. Wherein, the drum 10 is rotatably disposed in the headrail 1 and is adapted to be connected to an upper end of the ladder cord. The adjusting module includes a connection member 12 and a first protrusion member 14A. The drum 10 and the first protrusion member 14A are connected to the connection member 12 with the connection member 12 disposed therebetween. The details of each of the components mentioned above are described first, and then the method of utilizing the adjusting module will be explained. In other embodiments, the connection member 12 of the adjusting module 10 can be omitted. In such a case, the first protrusion member 14A could be directly assembled to the drum 10 via a structural design instead.

The drum 10 includes a tubular body 101. The tubular body 101 is provided with a core rod 102 therein. The core cord 102 includes a polygonal through-hole which could be inserted by a polygonal shaft (not shown), and therefore could be rotated along with the polygonal shaft driven by a modulation mechanism. However, the detail description of the polygonal shaft and the modulation mechanism are omitted here for simplification.

The tubular body 101 of the drum 10 includes a top wall which is flat and longitudinally provided with at least one slit 101a. In this embodiment, the top wall of the tubular body 101 is provided with two slits 101a going through the tubular body, connecting the outside and the inside thereof. The two slits 101a are parallel to each other and respectively include a closed end and an open end.

The ladder cord 4 includes a first longitudinal cord 4a, a second longitudinal cord 4b and a plurality of traverse cords 4c connected between the first longitudinal cord 4a and the second longitudinal cord 4b. Wherein, the slats 3 are positioned on the plurality of traverse cords 4c, such that the slats 3 are disposed between the first longitudinal cord 4a and the second longitudinal cord 4b, and are below the headrail 1. In addition, the upper ends of the first longitudinal cord 4a and the second longitudinal cord 4b are detachably connected to the drum 10. For example, the first longitudinal cord 4a and the second longitudinal cord 4b respectively pass through the corresponding slits 101a to be connected to the drum 10 through knots or fasteners. In this embodiment, each of the slits 101a includes a notch 101b and a protrusion 101c respectively formed on one of the sidewalls thereof. Wherein, each of the notches 101b is adapted to be abutted against by the knot of the corresponding first longitudinal cord 4a or second longitudinal cord 4b. Each of the protrusion 101c is disposed between the closed end of the belonged slit 101a and the corresponding notch 101b.

The connection member 12 is detachably connected to the drum 10. In this embodiment, the connection member 12 is a long and U-shaped plate having a longitudinal sliding groove 12a. The sliding groove 12 constitutes a close end 12b and an open end 12c on two sides of the connection member 12. The connection member 12 and the tubular body 101 of the drum 10 are configured as a sliding pair such that the connection member 12 would be only allowed to be detached from the drum 10 in an axial direction X rather than a radial direction Y.

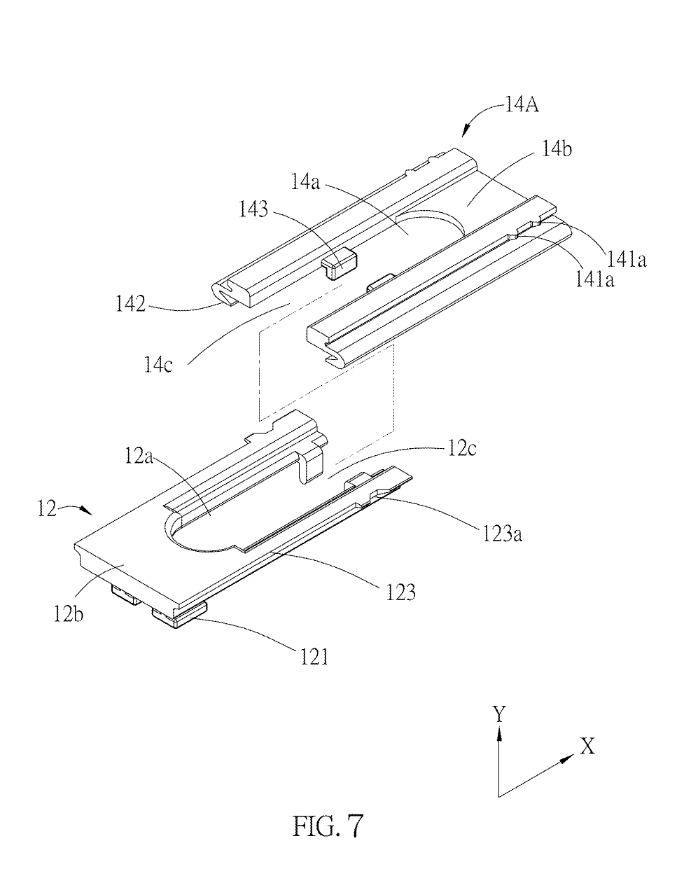

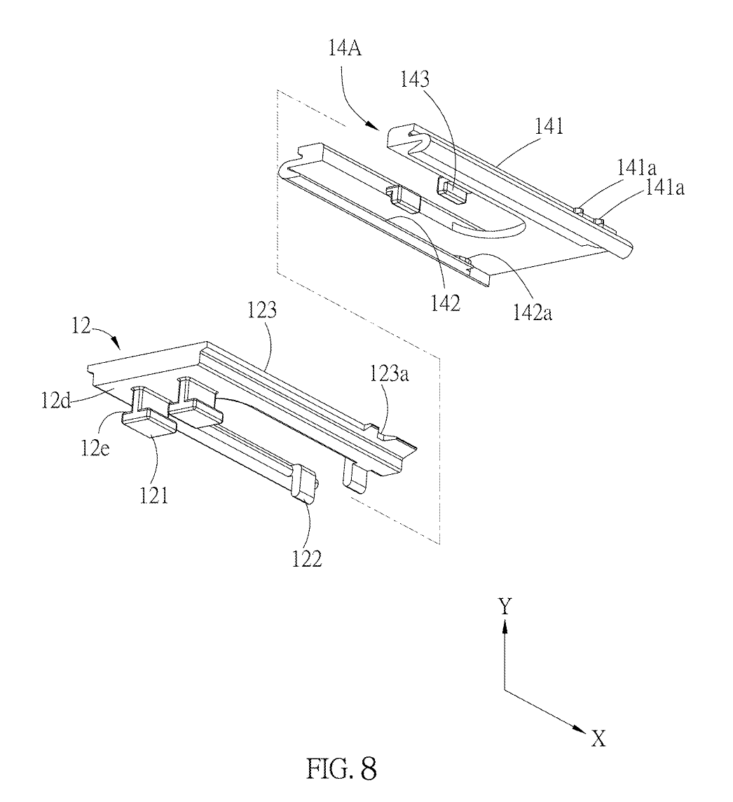

As shown in FIG. 7 and FIG. 8, on a bottom of the connection member 12, two T-shaped ribs 121 are provided close to the close end 12b while two positioning ribs 122 are provided close to the open end 12c, wherein the positioning ribs 122 extend downward. Wherein, a bottom surface of the connection member 12 and each of the T-shaped ribs 121 constitute a holding groove adapted for being connected to the tubular body 101. The holding groove includes two holding surfaces 12d and 12e which are opposite to each other, wherein one of the holding surfaces 12d is part of the bottom surface of the connection member 12, while the other one of the holding surfaces 12e is a surface of the corresponding T-shape rib 121. In addition, each of two longitudinal sides of the connection member 12 is respectively provided with an extending rib 123. Each of the extending ribs 123 includes a notch 123a close to the open end 12c of the connection member 12.

The first protrusion member 14A is detachably connected to the connection member 12. In this embodiment, the first protrusion member 14A is also a long and U-shaped plate having a longitudinal sliding groove 14a. The sliding groove 14a constitutes a close end 14b and an open end 14c on two sides of the first protrusion member 14A. The first protrusion member 14A and the connection member 12 are also configured as a sliding pair, such that the first protrusion member 14A would be only allowed to be detached from the connection member 12 in the axial direction X rather than the radial direction Y. Two longitudinal sides of an upper half part of the first protrusion member 14A are provided with two extending ribs 141. Each of the extending ribs 141 includes two position-limiting protrusions 141a near the closed end 14b. Two longitudinal sides of a lower half part of the first protrusion member 14A are provided with two hooks 142. Each of the hooks 142 includes a protrusion part 142a at one side of its interior surface near the close end 14b. In addition, two downwardly extending guiding blocks 143 are provided on each of two corresponding sidewalls of the guiding groove 14a.

The details of the components of the adjusting module of the first embodiment of the present invention are described above. The method for utilizing the adjusting module will be described hereinafter.

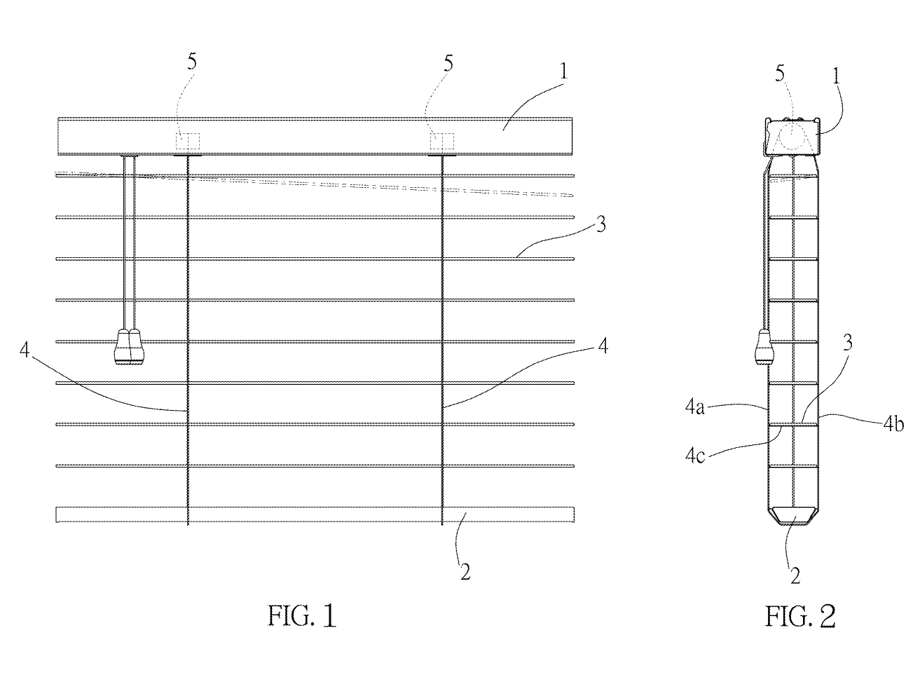

It shall be noted that the connection member 12 and the first protrusion member 14A of the present embodiment are adapted to adjust a traverse inclination of the slats 3, i.e., the situation illustrated by the imaginary lines shown in FIG. 1. On the contrary, when the slats 3 are remained in the horizontal state by the ladder cord 4 and another ladder cord on two sides of the window blind, it is not necessary to use the connection member 12 and the first protrusion member 14A. The premise of the following description is a condition that the knot or the fastener of one of the ladder cords 4 on the two sides of the window blind deviates from a normal position.

As shown in FIG. 4, if the slats 3 are found inclining sideways, the adjusting module of the present embodiment can be utilized without the need to retie the knot or reposition the fastener on any of the ladder cords 4. The procedure is as follows. First, on the lower side of the inclined slats 3, the open end 12c of the connection member 12 could be aligned with the open ends of the slits 101a of the drum 10. Then, the connection member 12 could slide into the tubular body 101 in a horizontal direction. During the process, the positioning ribs 122 of the connection member 12 would go into the slits 101a first, and then the T-shaped ribs 121 would enter the slits 101a.

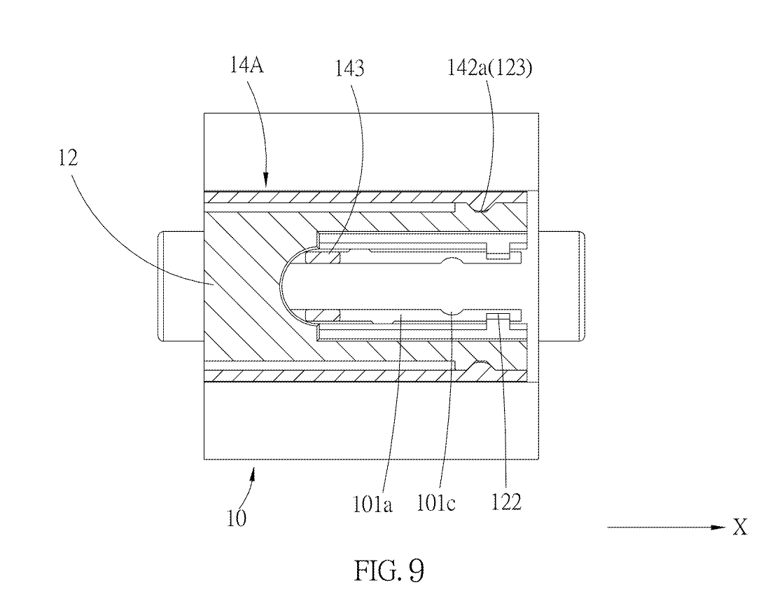

As shown in FIG. 9, the connection member 12 slid into the tubular body 101 would have its positioning ribs 122 disposed between the closed ends of the slits 101a and the protrusions 101c, and the positioning ribs 122 would abut against the protrusions 101c, whereby the connection member 12 would be only allowed to be moved in the axial direction X, and would not be detached from the drum 10 in a normal condition. Said normal condition refers to a condition that the connection member 12 has been combined with the drum 10. An external pulling force would be required to separate the connection member 12 from the drum 10. In addition to the positioning ribs 122 and the protrusions 101c mentioned above, a pair of at least one protrusion and at least one notch which correspond to each other would also work. That is, the positioning effect could be also achieved by providing a protrusion on one of the corresponding surfaces of the tubular body 101 and the connection member 12, and providing a notch on the other surface.

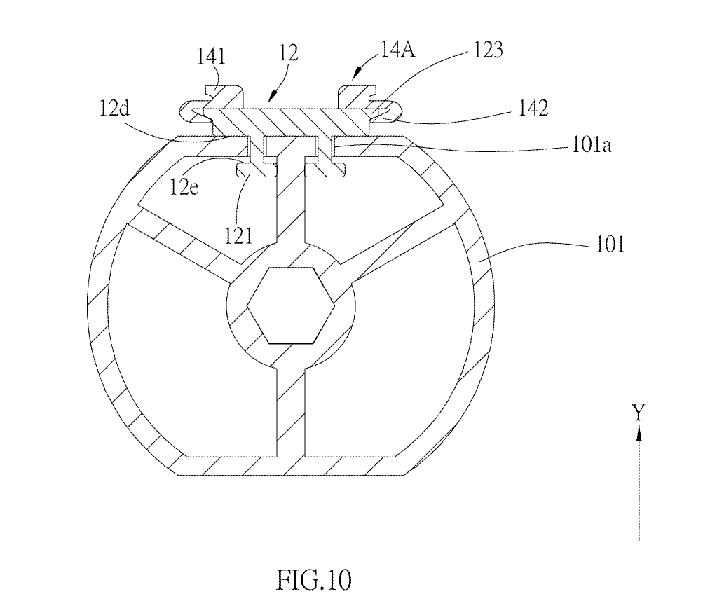

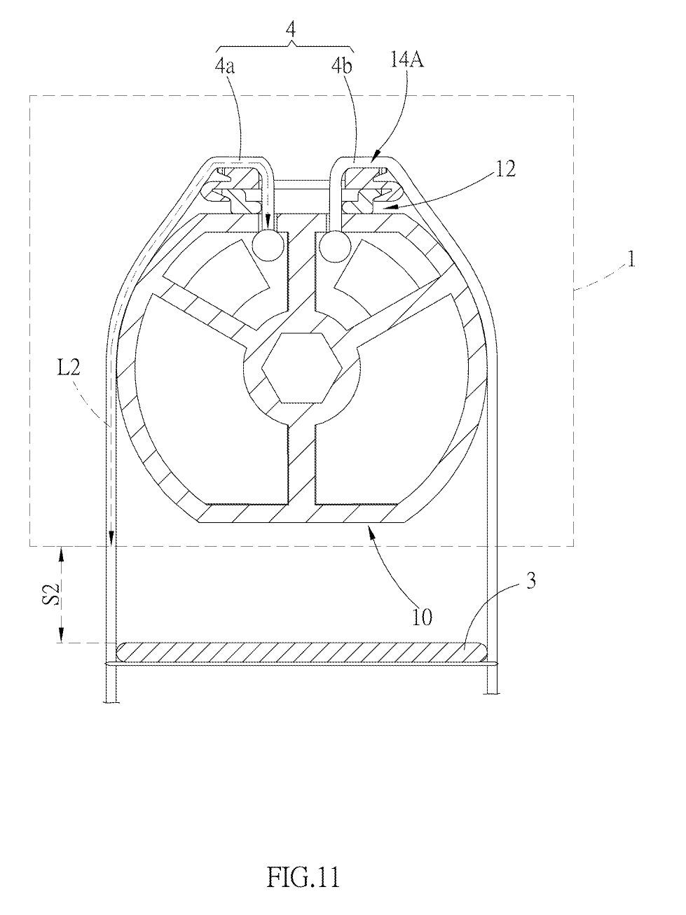

Besides, as shown in FIG. 10, the connection member 12 faces an exterior surface of the tubular body 101 with its holding surfaces 12d, and faces an interior surface of the tubular body 101 with its holding surfaces 12e. By abutting at least one holding surface 12d or 12e against the exterior surface or the interior surface of the tubular body 101, the connection member 12 cannot be detached from the drum 10 in the radial direction Y.

As shown in FIG. 4, FIG. 9 and FIG. 10, by aligning the open end 14c of the first protrusion member 14A with the open end 12c of the connection member 12, the first protrusion member 14A could be pushed in a horizontal direction to slide into the connection member 12, wherein the extending ribs 123 of the connection member 12 would be engaged with the hooks 142 of the first protrusion member 14A. In this way, the first protrusion member 14A could be only moved in the axial direction X, and therefore would not be detached from the connection member 12 in the radial direction Y. During the process, the guiding blocks 143 of the first protrusion member 14A would be in contact with the sidewalls of the sliding grooves 12a of the connection member 12 while being moved, and would abut against the bottoms of the sliding grooves 12a in the end. When the protrusion parts 142a of the first protrusion member 14A which protrude from an interior surfaces of the hooks 142 are engaged with the notches 123a recessed into the extending ribs 123 of the connection member 12, the first protrusion member 14A would be fixedly positioned, and would not be detached from the connection member 12 in the—axial direction X.

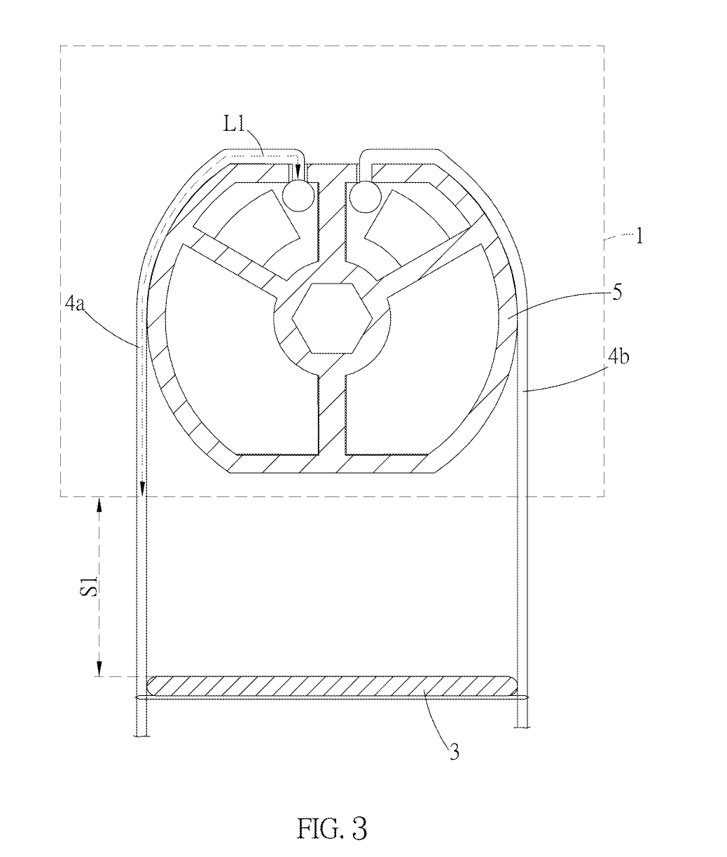

As shown in FIG. 3 and FIG. 11, when the connection member 12 and the first protrusion member 14A are not attached to the drum 10, a length of each of the first longitudinal cord 4a and the second longitudinal cord 4b received inside the headrail 1 is defined as a first routing length L1, and another length of each of the first longitudinal cord 4a and the second longitudinal cord 4b between the bottom edge of the headrail 1 and the slat 3 closest to the headrail 1 is defined as a first segment length S1. When the connection member 12 and the first protrusion member 14A are attached to the drum 10, the first protrusion member 14A is protruded outward from the drum 10 in a radial direction thereof, so that each of the first longitudinal cord 4a and the second longitudinal cord 4b would pass around an exterior surface of the first protrusion member 14A opposite to the drum 10 in the radial direction of the drum 10, and would touch the first protrusion member 14A. At this time, a length of each of the first longitudinal cord 4a and the second longitudinal cord 4b received inside the headrail 1 is defined as a second routing length L2, and another length of each of the first longitudinal cord 4a and the second longitudinal cord 4b between the bottom edge of the headrail 1 and the slat 3 closest to the headrail 1 is defined as a second segment length S2. The second routing length L2 is longer than the first routing length L1, and the second segment length S2 is shorter than the first segment length S1. It shall be noted that the sum of the first routing length L1 and the first segment length S1 is equal to the sum of the second routing length L2 and the second segment length S2.

The moving paths of the first longitudinal cord 4a and the second longitudinal cord 4b of the ladder cord 4 would be changed as the first longitudinal cord 4a and the second longitudinal cord 4b would have to wind around the first protrusion member 14A to turn downward. Whereby, with the first protrusion member 14A, the slats 3 could be easily adjusted from an inclined state to the horizontal state without the need to retie the knot or reposition the fastener on the upper end of the first longitudinal cord 4a or the second longitudinal cord 4b.

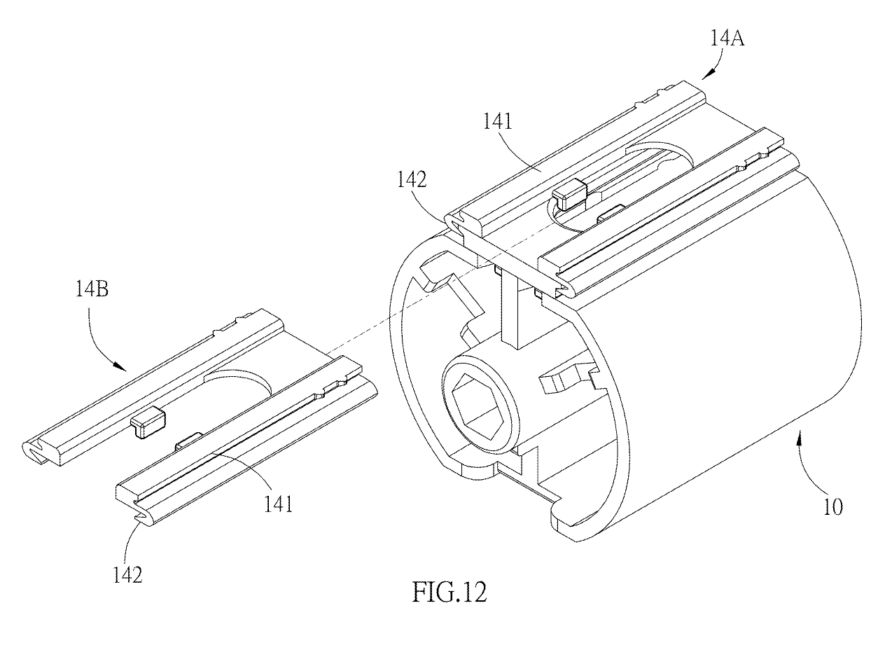

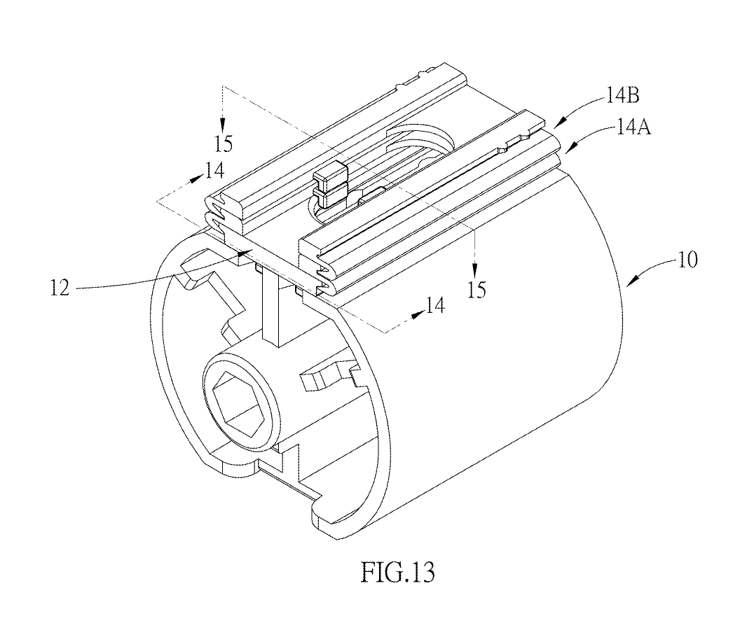

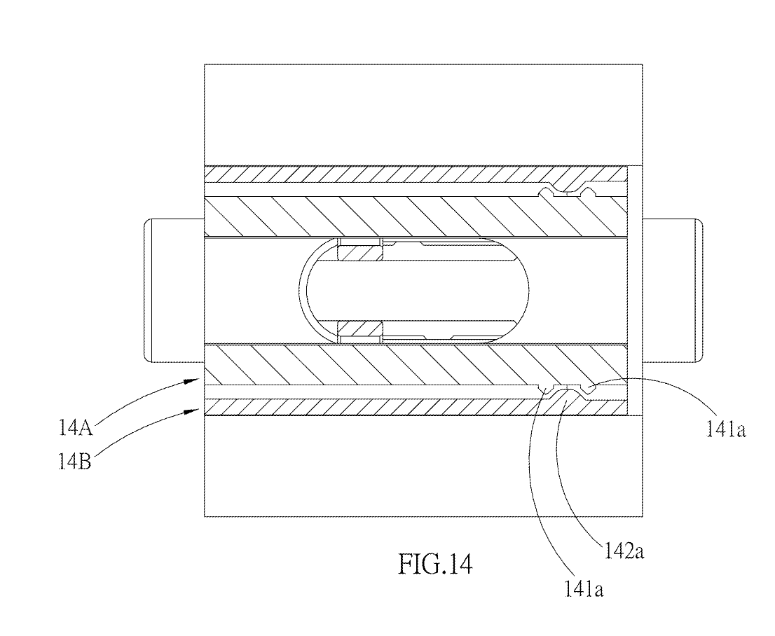

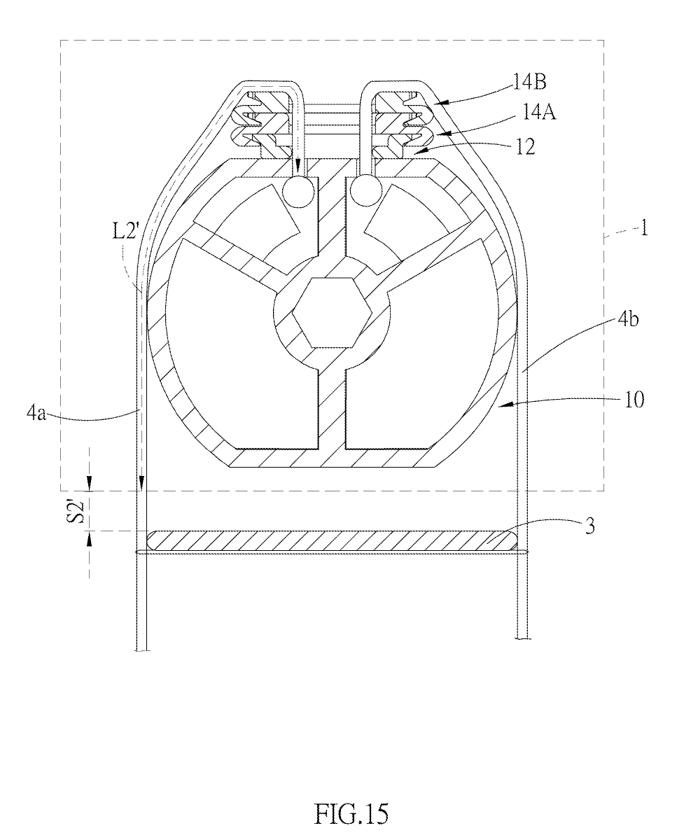

In addition, the adjusting module can further include at least one second protrusion member 14B. The second protrusion member 14B can be superimposed onto the first protrusion member 14A or be positioned adjacent to the first protrusion member 14A. The number of the second protrusion member 14B is not limited, and could be further increased depending on the requirements. The more the second protrusion members 14B are, the longer the second routing length L2 will be, and the shorter the second segment length S2 will be. As shown in FIG. 12 to FIG. 1S, a second embodiment of the present invention illustrates that the first protrusion member 14A and a second protrusion member 14B are stacked as being configured as a sliding pair. In this embodiment, the extending ribs 141 provided on the two longitudinal sides of the upper half part of the first protrusion member 14A are defined as a to-be-connected portion in the present invention, while the hooks 142 provided on the two longitudinal sides of the lower half part of the second protrusion member 14B are defined as a connecting portion in the present invention. Wherein, the second protrusion member 14B engages with the extending ribs 141 of the first protrusion member 14A through its hooks 142, such that the second protrusion member 14B and the first protrusion member 14A could be connected to each other as a sliding pair. In more details, each of the protrusion parts 142a of the second protrusion member 14B would be located between two of the position-limiting protrusions 141a on the extending ribs 141 on one side of the first protrusion member 14A. Hence, the movement of the second protrusion member 14B would be restricted. Similarly, when the number of the second protrusion member 14B is more than one, and when the plurality of second protrusion members 14B are stacked together, each of the second protrusion members 14B includes the to-be-connected portion and the connecting portion. More specifically, for every two stacked second protrusion members 14B, the extending ribs 141 provided on the two longitudinal sides of the upper half part of the second protrusion member 14B located below are defined as the to- be-connected portion in the present invention, while the hooks 142 provided on the two longitudinal sides of the lower half part of the second protrusion member 14B located above are defined as the connecting portion in the present invention. Wherein, the second protrusion member 14B located above engages with the extending ribs 141 of the second protrusion member 14B located below through its hooks 142, such that these two second protrusion members 14B could be connected with each other as a sliding pair. In more details, each of the protrusion parts 142a of the second protrusion member 14B located above would be located between two of the position-limiting protrusions 141a of on the extending ribs 141 on one side of the second protrusion member 14A located below. Hence, the movement of the second protrusion member 14B located above would be restricted.

As it can be seen by comparing FIG. 11 and FIG. 15, in the condition that the first protrusion member 14A and the second protrusion member 14B are both assembled to the drum 10, the corresponding second routing length L2′ would be longer than the second routing length L2 when there is only the first protrusion member 12 assembled to the drum 10. Hence, the second segment length S2′ corresponding to the second routing length L2′ would be shorter than the second segment length S2 corresponding to the second routing length L2. Since the second protrusion member 14B is disposed on the first protrusion member 14A in a radial direction and is protruded outward therefrom, each of the first longitudinal cord 4a and the second longitudinal cord 4b of the ladder cord 4 on one side would have to wind around the first protrusion member 14A and the second protrusion member 14B, whereby the second routing length L2′ inside of the headrail 1 would be increased, while the second segment length S2′ would be reduced. Therefore, such configuration would be suitable to adjust slats having a greater inclined angle.

In addition, the first protrusion member 14A and the second protrusion member 14B both have a thickness in the radial direction of the drum 10. The thicker each of the protrusion members 14A 14B is, the longer the second routing length L2′ will be, so that the second segment length S2′ will be shorter as well. Similarly, in another embodiment, the number of the first protrusion member 14A could be more than one, and the way of arranging the multiple first protrusion members 14A is not limited to stacking as exemplified above. As long as the second routing length L2′ can be changed to consequently shorten the second segment length S2′, different arrangements for the first protrusion members 14A would be also feasible.

In the above embodiments, the drum 10, the connection member 12 and the first protrusion member 14A are connected to one another in sliding pairs, and therefore these components could be assembled quickly. In practice, however, the configurations are not limited to sliding pairs; these components could be also engaged through snap-fitting. It has to be mentioned that, the drum 10 and the first protrusion member 14A are connected through the connection member 12 in the aforementioned embodiments; however, in other embodiments, the connection member 12 could be also omitted if the first protrusion member 14A could be assembled to the drum 10 directly. For example, the first protrusion member 14A could have T-shaped ribs similar to those provided on the bottom of the connection member 12, and such design would allow the first protrusion member 14A and the drum 10 to be connected as a sliding pair, whereby the first protrusion member 14A would be prevented from detaching from the drum 10 as well. For another example, the drum 10 could include extending ribs similar to those of the connection member 12 on a top thereof, whereby the first protrusion member 14A could be assembled with the drum 10 by being engaged with said extending ribs through its hooks 142. In this way, the connection member 12 would be not necessary either. In addition, the drum 10 could further include either at least one protrusion part or at least one notch, while the first protrusion member 14A correspondingly having either at least one notch or at least one protrusion part. Whereby, the protrusion part and the notch could correspond to each other so as to prevent the first protrusion member 14A from detaching from the drum 10.

The structures disclosed in the above embodiments would be suitable for adjusting the slats 3 which only incline sideways but not forward or backward. The following embodiments would be adapted to adjust the slats which incline sideways, forward, or backward.

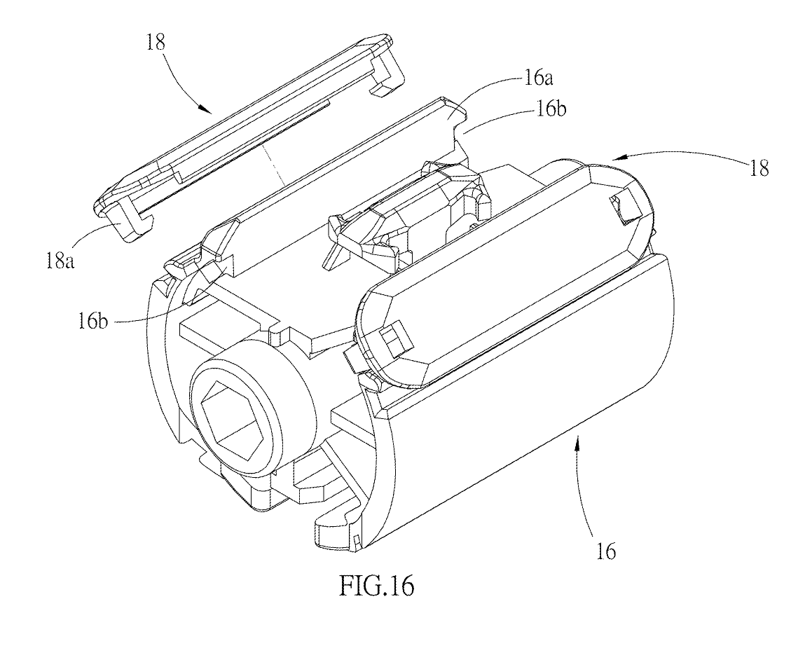

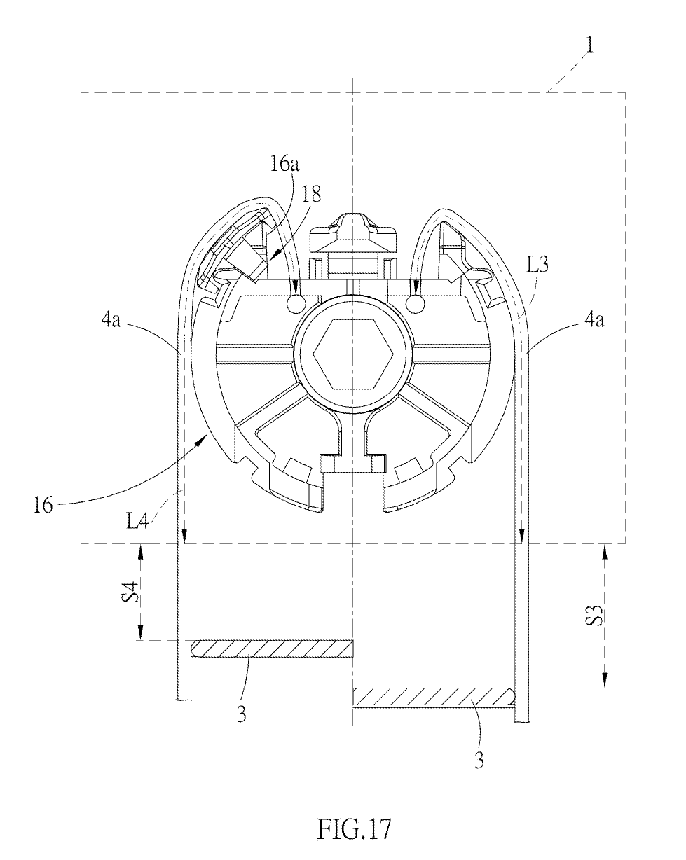

A third embodiment of the present invention is illustrated in FIG. 16 and FIG. 17. Two sidewalls 16a are formed on a top of the drum 16 in a longitudinal direction thereof. Two ends of each of the sidewalls 16a are respectively provided with a notch 16b. The first protrusion member 18 is long, and has two hooks 18a provided at two ends thereof respectively. The first protrusion member 18 can be assembled to the drum 16 by engaging the hooks 18a with the notches 16b of the drum 16.

FIG. 17 compares the situations with or without the first protrusion member 18, wherein the right half of FIG. 17 is shown in mirror image for easier comparison. Before assembling the first protrusion member 18 to the drum 16, a routing length of the first longitudinal cord 4a or the second longitudinal cord 4b inside of the headrail 1 is defined as a first routing length L3, and a length of the first longitudinal cord 4a or the second longitudinal cord 4b between the bottom edge of the headrail 1 and the slat 3 closest to the headrail 1 is defined as a first segment length S3. After assembling the first protrusion member 18 to the drum 16, the first protrusion member 18 would protrude outward from the drum 16 in the radial direction thereof. The corresponding longitudinal cord, which is the first longitudinal cord 4a as an example, would wind around an exterior surface of the first protrusion member 18 opposite to the drum 10, and would touch the first protrusion member 18. At this time, a routing length of the first longitudinal cord 4a inside of the headrail 1 is defined as a second routing length L4, and a length of the first longitudinal cord 4a between the bottom edge of the headrail 1 and the slat 3 closest to the headrail 1 is defined as a second segment length S4.

As shown in FIG. 17, the second routing length L4 is longer than the first routing length L3, and therefore the second segment length S4 is shorter than the first segment length S3. If the slats 3 only incline sideways but not forward or backward, the lower ends of the slats could be effectively pulled up by engaging two first protrusion members 18 with the sidewalls 16a of the drum 16 respectively, i.e., one on the front side and the other one on the rear side. On the other hand, if the slats 3 incline forward or backward, the lower side of the slats 3 could be effectively pulled up by engaging only one first protrusion member 18 with the corresponding sidewall 16a of the drum 16 to wind the corresponding longitudinal cord 4a or 4b around the first protrusion member 18.

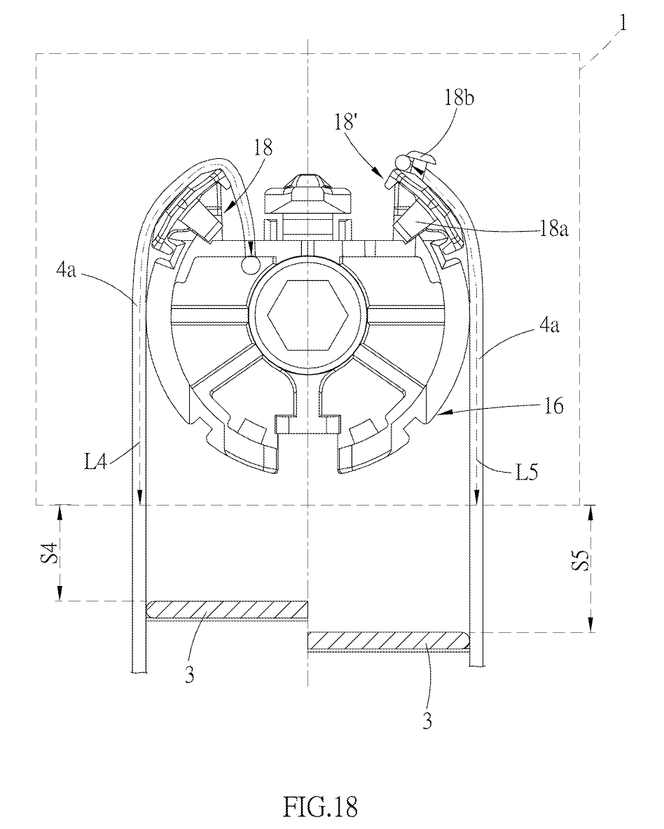

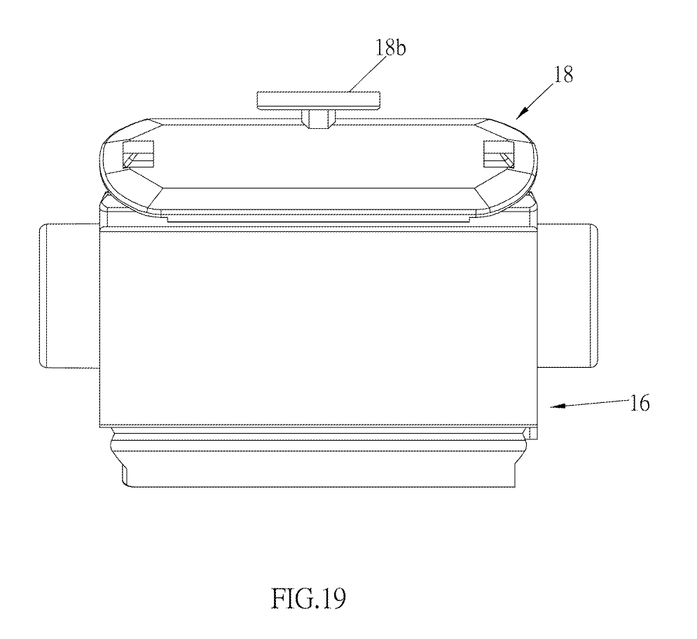

A fourth embodiment of the present invention is illustrated in FIG. 18 and FIG. 19. The fourth embodiment is different from the third embodiment in that, the first protrusion member 18′ of the fourth embodiment further includes an upward extending tethering pan 18b, which is substantially T-shaped. FIG. 18 compares the situations when an upper end of the longitudinal cord (which is the first longitudinal cord 4a as an example) is connected to the drum 10 or the tethering pan 18b, wherein the right half of FIG. 18 is shown in mirror image for easier comparison. In practice, the upper end of the first longitudinal cord 4a or the second longitudinal cord 4b could be released from the drum 16 and connected to the tethering part 18b, such that a routing length of the first longitudinal cord 4a or the second longitudinal cord 4b inside the headrail 1 is defined as a third routing length L5, and a length of the first longitudinal cord 4a or the second longitudinal cord 4b between the bottom edge of the headrail 1 and the slat 3 closest to the headrail 1 is defined as a third segment length S5. In this embodiment, the third routing length L5 is shorter than the second routing length L4 but longer than the first routing length L3, and therefore the third segment length S5 is between the second segment length S4 and the first segment length S3. Whereby, according to the inclination of the slats 3, the user could choose to connect the corresponding longitudinal cord (which is the first longitudinal cord 4a as an example) to the drum 16 or to the tethering pan 18b. More specifically, if an inclined angle of the slats 3 is great, the first longitudinal cord 4a could be connected to the drum 16; on the other hand, if the inclined angle of the slats 3 is less, the first longitudinal cord 4a could be connected to the tethering part 18b instead. In this way, the inclined angle of the slats 3 could be adjusted.

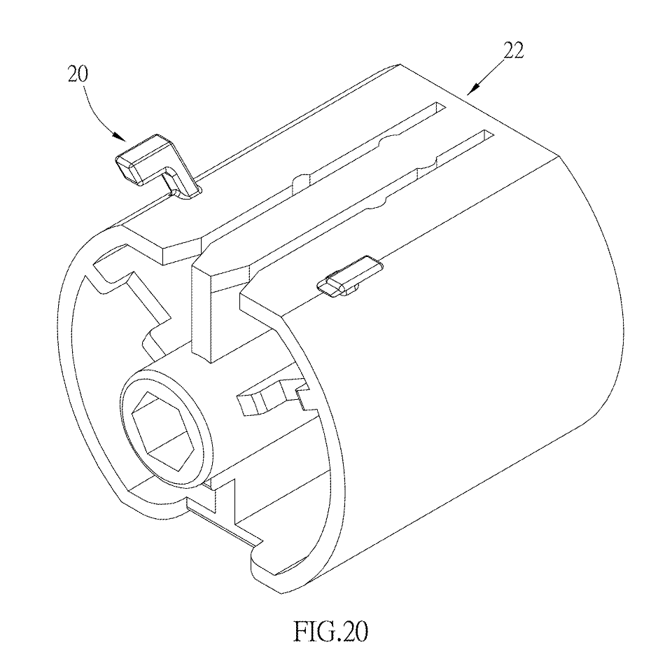

A fifth embodiment of the present invention is illustrated in FIG. 20 to FIG. 23, wherein a first protrusion member 20 is attached to the drum 22 corresponding to each of the first longitudinal cord 4a and the second longitudinal cord 4b. Wherein, a first part 22a is defined on the drum 22 at where an upper end of each of the first longitudinal cord 4a and the second longitudinal cord 4b connected to, and a second part 22b is defined on the drum 22 at where each of the first longitudinal cord 4a and the second longitudinal cord 4b starts to turn downward from a top surface of the drum 22 without passing around and contacting the corresponding first protrusion member 20.

Each of the first protrusion members 20 includes at least one blocking portion 20a connected to the top surface of the drum 20. In this embodiment, each of the blocking portions 20a protrudes outward in a radial direction of the drum 22. On each side of the drum 22, the blocking portion 20a, the first part 22a, and the second part 22b are not aligned. Each of the first protrusion members 20 further includes an extension portion 20b. The extension portion 20b is connected to a top of the blocking portion 20a and extends in a direction away from the second part 22b. In an embodiment of the present invention, the first protrusion members 20 and the drum 22 are formed integrally.

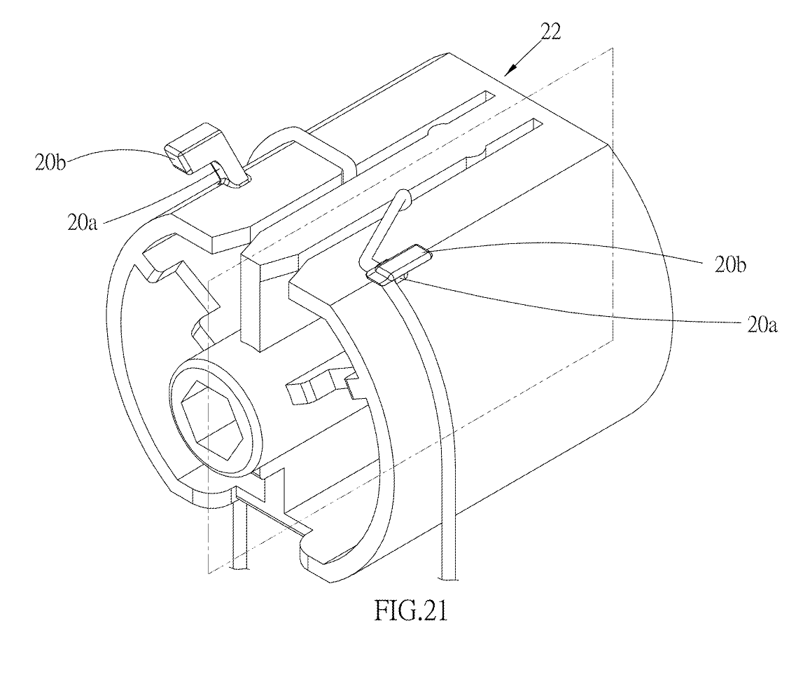

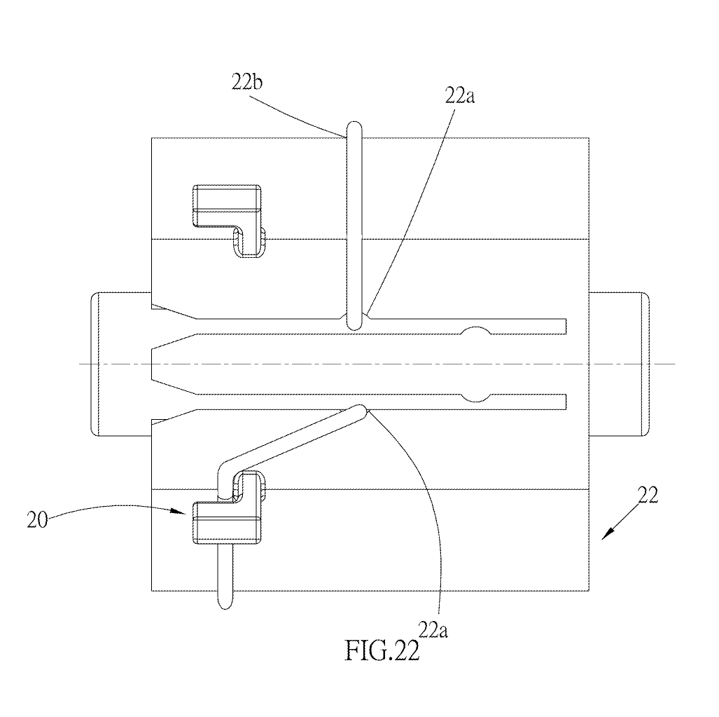

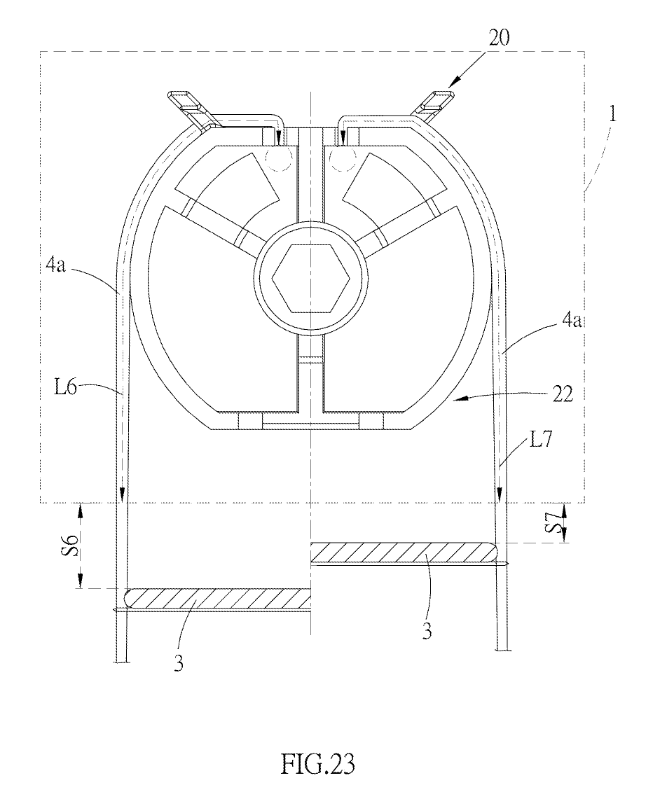

When the first longitudinal cord 4a or the second longitudinal cord 4b is connected to the drum 22 without passing around and contacting the corresponding first protrusion member 20, a length of the first longitudinal cord 4a or the second longitudinal cord 4b located inside the headrail 1 is defined as a first routing length L6, and a length of the first longitudinal cord 4a or the second longitudinal cord 4b between the bottom edge of the headrail 1 and the slat 3 closest to the headrail 1 is defined as a first segment length S6. When the first longitudinal cord 4a or the second longitudinal cord 4b passes around the blocking portion 22a of the corresponding first protrusion member 20 and then turns downward from the top surface of the drum 22, a length of the first longitudinal cord 4a or the second longitudinal cord 4b located inside the headrail 1 is defined as a second routing length L7, and a length of the first longitudinal cord 4a or the second longitudinal cord 4b between the bottom edge of the headrail 1 and the slat 3 closest to the headrail 1 is defined as a second length S7. In FIG. 21 to FIG. 23, the first longitudinal cord 4a is taken as an example for illustration, wherein the right side of FIG. 21 and FIG. 23 and the bottom right side of FIG. 22 are shown in mirror images for easier comparison.

Since a distance between the first part 22a of the drum 22 and the blocking portion 20a of the first protrusion member 20 is greater than a distance between the first part 22a and the second part 22b on each side of the drum 22, the second routing length L7 is longer than the first routing length L6, while the second segment length S7 is shorter than the first segment length S6. In addition, since the extension portion 20b is disposed on the top of the blocking portion 20a in a way that each of the first protrusion members 20 is in a horn-like shape, the first longitudinal cord 4a or the second longitudinal cord 4b winds around the corresponding blocking portion 20a would not escape from the corresponding first protrusion member 20 due to a rotation of the drum 22.

No matter the slats incline sideways, forward, or rearward, the lower end of the slats 3 could be easily pulled up to keep the slats 3 in horizontal by making the first longitudinal cord 4a or the second longitudinal cord 4b on the lower side pass around the corresponding first protrusion member 20.

In the above embodiments, the drum and the ladder cord have a one-to-one configuration. However, in conventional window blinds, a one-to-many configuration between the drum and the ladder cords is also feasible. For example, a single drum is arranged in the headrail, and multiple ladder cords each has its longitudinal cords passing through one (or two) of the multiple through holes provided on the bottom edge of the headrail. For each of the ladder cords, part of each of the longitudinal cords extends into the headrail in a direction toward the drum and gets connected to the drum. In response to such a configuration, one or more first protrusion members could be assembled in a manner different from those described in the embodiments above. That is, the first protrusion member(s) could be assembled on the headrail, instead of on the drum. Similarly, the longitudinal cords extending into the headrail in the direction toward the drum could each has part thereof passing around and contacting the corresponding first protrusion member positioned on the headrail, resulting in having the second routing length longer than the first routing length, and having the second segment length shorter than the first segment length.

In summary, in each of the aforementioned embodiments, the sum of the first routing length and the first segment length is equal to the sum of the second routing length and the second segment length. The first protrusion member (and the second protrusion member) are both arranged in the moving path of one first longitudinal cord or one second longitudinal cord inside of the headrail. Hence, when one first longitudinal cord or one second longitudinal cord winds around or passes around the corresponding first protrusion member (and/or the second protrusion member), the length of the longitudinal cord received inside the headrail would be increased as the second routing length, which is longer than the first routing length. As a result, the second segment length would be shorter than the first segment length. Particularly, when one longitudinal cord winds around the corresponding first protrusion member (and/or the second protrusion member) for multiple times to increase the turns, the deformations, and the number of bends thereof, the resultant second routing length would be even longer, and the resultant second segment length would be even shorter as well.

The configurations disclosed in the above embodiments would be adapted to adjust the slats into a horizontal state without the need to retie the knots or reposition the fasteners. Therefore, it could fix imperfection window blinds without increasing burdens or troubles for the manufacturers or the users. It must be pointed out that the embodiments described above are only some embodiments of the present invention. All equivalent structures which employ the concepts disclosed in this specification and the appended claims should fall within the scope of the present invention.

What is claimed is:

1. An adjusting module for a window blind, which comprises a headrail, a slat, a drum and a ladder cord, wherein the drum is disposed in the headrail in a rotatable manner; the ladder cord comprises a first longitudinal cord and a second longitudinal cord; an upper end of each of the first longitudinal cord and the second longitudinal cord is detachably connected to the drum; the slat is below the headrail, and is disposed between the first longitudinal cord and the second longitudinal cord; a length of the first longitudinal cord received inside the headrail is defined as a first routing length; a length of the first longitudinal cord between a bottom edge of the headrail and the slat is defined as a first segment length; comprising:
a first protrusion member disposed in the headrail, wherein, when the first longitudinal cord passes around and contacts the first protrusion member, a length of the first longitudinal cord received inside the headrail is defined as a second routing length, and a length of the first longitudinal cord between the bottom edge of the headrail and the slat is defined as a second segment length; the second routing length is longer than the first routing length, and the second segment length is shorter than the first segment length.

2. The adjusting module of claim 1, wherein a sum of the first routing length and the first segment length is equal to a sum of the second routing length and the second segment length.

3. The adjusting module of claim 1, wherein the first longitudinal cord turns or winds around the first protrusion member for at least once at where the first longitudinal cord contacts the first protrusion, so as to increase the second routing length thereof, and shorten the second segment length thereof; the second segment length is shorter when the first longitudinal cord has a greater deformation at where the first longitudinal cord turns or when the first longitudinal cord winds around the first protrusion member for more times.

4. The adjusting module of claim 1, further comprising at least one second protrusion member, which is adapted to be superimposed on or disposed adjacent to the first protrusion member, wherein the first longitudinal cord both passes around the first protrusion member and the at least one second protrusion member; when a number of the at least one second protrusion member passed around by the first longitudinal cord increases, the second routing length thereof increases, and the second segment length shortens.

5. The adjusting module of claim 3, wherein the first protrusion member is disposed on the drum and is protruded outward in a radial direction of the drum.

6. The adjusting module of claim 5, further comprising at least one second protrusion member, wherein the second protrusion member is disposed on the first protrusion member and is protruded outward in the radial direction of the drum; the first longitudinal cord both passes around and contacts the first protrusion member and the at least one second protrusion member, so as to increase the second routing length thereof and to shorten the second segment length thereof.

7. The adjusting module of claim 5, wherein the first protrusion member has a thickness in the radial direction of the drum; if the thickness of the first protrusion member becomes greater, the second routing length is longer and the second segment length is shorter.

8. The adjusting module of claim 5, wherein the first protrusion member further comprises a tethering part; the upper end of the first longitudinal cord can be detached from the drum and connected to the tethering part; when the upper end of the first longitudinal cord is connected to the tethering part, a length of the first longitudinal cord between the bottom edge of the headrail and the slat is defined as a third cord length, which is shorter than the first segment length and longer than the second segment length.

9. The adjusting module of claim 5, wherein the first protrusion member comprises at least one blocking portion; the at least one blocking portion is disposed on the drum; the first longitudinal cord passes around and contacts a surface of the first protrusion member opposite to the drum in the radial direction of the drum.

10. The adjusting module of claim 5, wherein the first protrusion member comprises at least one blocking portion; the at least one blocking portion is connected to the drum; the first longitudinal cord passes around and contacts the at least one blocking portion of the first protrusion member.

11. The adjusting module of claim 5, wherein the first protrusion member and the drum are engaged with each other as a sliding pair, such that the first protrusion member cannot be detached from the drum in the radial direction of the drum.

12. The adjusting module of claim 5, wherein the drum comprises either at least one protrusion part or at least one notch, while the first protrusion member comprises the at least one protrusion part or the at least one notch not included in the drum; the at least one notch and the at least one protrusion part match each other, so as to restrict the first protrusion member from being detached from the drum.

13. The adjusting module of claim 5, further comprises a connection member disposed between the drum and the first protrusion member; the connection member is detachably connected to the drum, and the first protrusion member is detachably connected to the connection member.

14. The adjusting module of claim 4, wherein the at least one second protrusion member comprises a plurality of second protrusion members; each of the second protrusion members comprises a connecting portion and a to-be-connected portion; the to-be-connected portion of one of the second protrusion members engages with the connecting portion of another one of the second protrusion member which is stacked thereon.
